(19) United States
(12) Patent Application Publication
(10) Pub. No.: US 2005/0201358 A1
(43) Pub. Date: Sep. 15, 2005

(54) Rotating media channels between resources of an emergency services network and conforming emergency systems

(75) Inventors: Michael Jay Nelson, Louisville, CO (US); Gregory Wilfred Bruening, Boulder, CO (US); Stephen Lynn Bulick, Boulder, CO (US); Edward Kizhner, Colorado Springs, CO (US); Stephen Marc Meer, Niwot, CO (US); Dennis Michael Neumayer, Golden, CO (US); Robert Allen Sherry, Aurora, IL (US)

Correspondence Address: SETTER OLLILA, LLC, 2060 BROADWAY, SUITE 300, BOULDER, CO, 80302, US

(73) Assignee: Intrado Inc., Longmont, CO (US)

(21) Appl. No.: 10/816,634

(22) Filed: Apr. 2, 2004

Related U.S. Application Data
(60) Provisional application No. 60/552,916, filed on Mar. 13, 2004.

(51) Int. Cl. H04L 12/28

(52) U.S. Cl. 370/352; 370/401; 455/404.1

(57) ABSTRACT

The invention includes a communication network for rotating media channels between resources of an emergency services network and a conforming emergency system (CES). A conforming emergency system and one of the resources of the emergency services network dynamically establish a first media channel between one another over a transport network. With the first media channel established, the conforming emergency system and the resource exchange messages over the first media channel to facilitate the CES in handling emergency events. Responsive to a triggering event, the CES and one of the resources (the same or another resource) dynamically establish a second media channel between one another over the transport network. With the second media channel established, the conforming emergency system and the resource exchange messages over the second media channel to facilitate the CES in handling emergency events. The first media channel may be torn down.

### RELATED APPLICATIONS

This non-provisional application claims priority to U.S. provisional application 60/552,916, which was filed on Mar. 13, 2004.

### BACKGROUND OF THE INVENTION

1. Field of the Invention

The invention is related to the field of emergency services, and in particular, to networks, methods, and systems for rotating media channels between resources of an emergency services network and conforming emergency systems.

2. Statement of the Problem

In the United States, basic 9-1-1 service is an emergency reporting service where a calling party can dial 9-1-1 in emergency situations. The call is answered at a Public Safety Answering Point (PSAP, also known as a “Public Safety Access Point”). An operator at the PSAP converses with the calling party to determine information on the emergency situation. For instance, the operator may ask the calling party for his/her name, the nature of the emergency, and the location of the emergency, etc. Based on the information gathered by the operator, the operator then contacts emergency personnel to respond to the emergency.

Enhanced 9-1-1 service (E9-1-1) has the added feature of automatically providing the operator with some information on the calling party. For instance, E9-1-1 service includes the added features of Automatic Number Identification (ANI) and Automatic Location Identification (ALI). With Automatic Number Identification (ANI), the operator is automatically provided with telephone number of the phone placing the call for emergency services (e.g., a 9-1-1 call). With Automatic Location Identification (ALI), the PSAP, or another device, queries an ALI database for information on the physical location of the calling party's phone. An ALI database stores records of telephone numbers. A record in the ALI database contains information (such as a street address) on a physical location that corresponds with a telephone number. Responsive to a query from the PSAP, the ALI database returns the location information for the calling party. With the telephone number and the location information, the operator can more effectively handle the emergency call. Other countries have emergency services similar to this.

Traditional communication networks have a rigid architecture when it comes to connecting to an emergency services network. In a traditional communication network, a PSAP connects to a pair of ALI databases in the emergency services network. The PSAP connects to each ALI database over a fixed and dedicated point-to-point connection. It may be problematic that a PSAP can only connect with a pair of ALI databases and the PSAP does not have the ability to connect with other ALI databases or resources.

If one of the ALI databases were to be taken out of service for maintenance or upgrades, then the PSAP would be connected to a single ALI database and would become one-sided. If the remaining ALI database was to go out of service, then the PSAP would not be able to adequately service emergency calls (e.g., 9-1-1 calls, 1-1-2 calls, etc.). Emergency services administrators try to avoid architectures that rely on a single device or system because of the higher possibility of a service outage. The emergency services administrators also worry about how the network would handle a failure and recovery event. Generally, the administrators have to wait until a failure occurs to determine the effectiveness of the recovery efforts.

With this architecture, it may also be problematic to add a new ALI database. If a new ALI database were to be added, dedicated point-to-point connections with the PSAPs would have to be established and the PSAPs would have to be programmed. There would be significant overhead and risk associated with adding a new ALI database.

### SUMMARY OF THE SOLUTION

The invention helps solve the above and other problems by rotating media channels between resources of an emergency services network and conforming emergency systems (e.g., PSAPs or other conforming systems). Rotating the media channels provides for a routine balancing of the media channels between resources of the emergency services network and conforming emergency systems. Rotating the media channels also provides for routine testing of the ability to gracefully drop a media channel and then re-establish another media channel. Dropping and re-establishing media channels resembles what would take place for a failure and recovery event, so the system should be adept at recovering from a failure. Rotating the media channels also allows resources of the emergency services network to be taken out of-service without impact to maintenance personnel or a disruption in nominal processing scenarios. Rotating the media channels also allows for easier addition of additional resources and load distribution to a new resource without manual intervention.

One embodiment of the invention comprises a communication network for rotating media channels between resources of an emergency services network and a conforming emergency system. A conforming emergency system and one of the resources of the emergency services network dynamically establish a first media channel between one another over a transport network. The communication network may use Session Initiation Protocol (SIP) or another protocol or means to dynamically establish the media channels. With the first media channel established, the conforming emergency system and the resource exchange messages over the first media channel to facilitate the conforming emergency system in handling emergency events. Responsive to a triggering event, the conforming emergency system and one of the resources (the same or another resource) dynamically establish a second media channel between one another over the transport network. With the second media channel established, the conforming emergency system and the resource exchange messages over the second media channel to facilitate the CES in handling emergency events.

The conforming emergency system, the resource, or another system may tear down the first media channel after the second media channel is established, before the second media channel is established, or simultaneously as the second media channel is established. Current message sessions over the first media channel may be allowed to end before tearing down the first media channel, or current message sessions over the first media channel may be rolled onto the second media channel.

The communication network rotates media channels periodically as described above. Responsive to subsequent triggering events, the conforming emergency system dynamically establishes a third media channel, a fourth media channel, and so on.

Another embodiment of the invention comprises a conforming emergency system for rotating media channels with resources of an emergency services network. The conforming emergency system includes a channel system and a message system. The channel system dynamically establishes a first media channel with a resource of the emergency services network. With the first media channel established, the message system may then exchange messages over the first media channel with the resource to facilitate the conforming emergency system in handling emergency events. Responsive to a triggering event, the channel system dynamically establishes a second media channel with a resource (the same or another resource) of the emergency services network. With the second media channel established, the message system may then exchange messages over the second media channel with the resource to facilitate the conforming emergency system in handling emergency events.

The invention may include other networks, systems, and methods described below.

### DESCRIPTION OF THE DRAWINGS

The same reference number represents the same element on all drawings.

FIG. 1 illustrates a communication network that provides emergency services in the prior art, such as 9-1-1 service in the United States.

FIG. 2A illustrates a communication network in an exemplary embodiment of the invention.

FIG. 2B is a flow chart illustrating a method for operating the communication network in FIG. 2A in an exemplary embodiment of the invention.

FIG. 2C is a flow chart illustrating another method for operating the communication network in FIG. 2A in an exemplary embodiment of the invention.

FIG. 2D is a flow chart illustrating another method for operating the communication network in FIG. 2A in an exemplary embodiment of the invention.

FIG. 3A illustrates the communication network in FIG. 2A further including a channel setup system in an exemplary embodiment of the invention.

FIG. 3B is a flow chart illustrating a method for operating the communication network in FIG. 3A in an exemplary embodiment of the invention.

FIG. 3C is a flow chart illustrating another method for operating the communication network in FIG. 3A in an exemplary embodiment of the invention.

FIG. 4 illustrates a channel setup system in an exemplary embodiment of the invention.

FIG. 5 illustrates another communication network in an exemplary embodiment of the invention.

### DETAILED DESCRIPTION OF THE INVENTION

### DESCRIPTION OF THE PRIOR ART

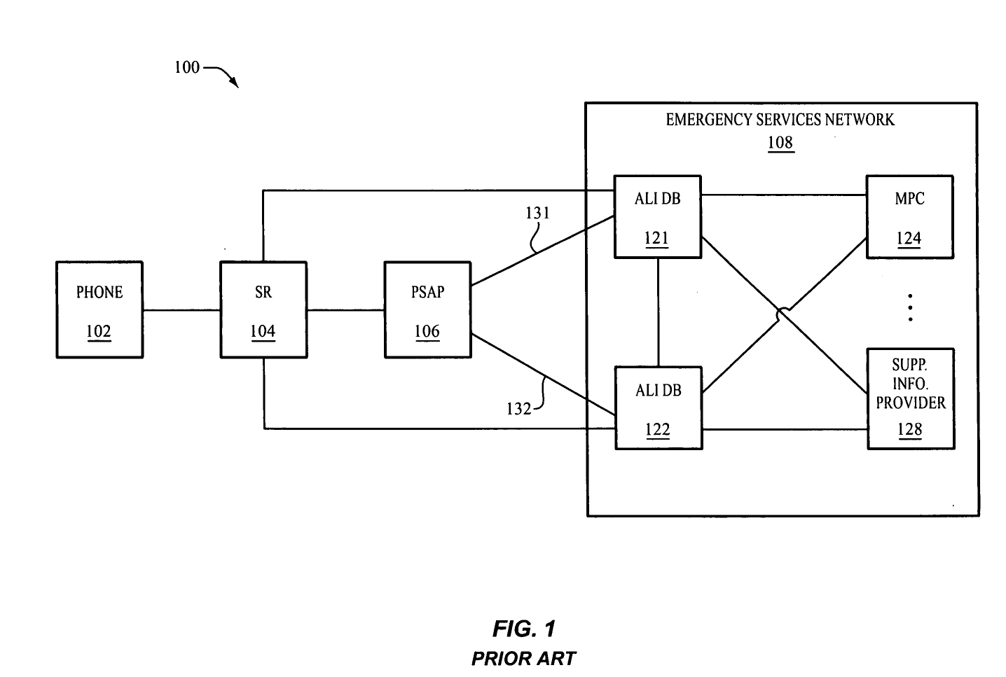

FIG. 1 illustrates a prior art communication network 100 that provides emergency services. Communication network 100 includes a telephone 102, a selective router (SR) 104, a Public Safety Answering Point (PSAP) 106, and an emergency services network 108. Emergency services network 108 includes two ALI databases 121-122, a Mobile Positioning Center (MPC) 124 (or a Gateway Mobile Location Center (GMLC)), a supplemental information provider 128, and other backend resources (not shown). Although a single MPC 124 and a single supplemental information provider 128 are illustrated in FIG. 1, emergency services network 108 generally includes multiple MPCs and supplemental information providers. As shown in FIG. 1, telephone 102 is connected to selective router 104. Selective router 104 is connected to PSAP 106 and ALI databases 121-122. PSAP 106 is connected to ALI databases 121-122. ALI database 121 is connected to ALI database 122, MPC 124, and supplemental information provider 128. ALI database 122 is connected to ALI database 121, MPC 124, and supplemental information provider 128.

Paired ALI databases 121-122 are used in emergency services networks, such as emergency service network 108, to add redundancy and reliability into the network. Each PSAP 106 (only one is shown) connects to two ALI databases 121-122. For the PSAP-ALI interface, PSAP 106 is connected to ALI database 121 by a dedicated point-to-point connection 131, and is connected to ALI database 122 by a dedicated point-to-point connection 132. The PSAP-ALI interface traditionally includes fixed point-to-point data circuits utilizing asynchronous data modems for the dedicated connections 131-132. In newer versions of the PSAP-ALI interface, dedicated connections 131-132 may include an upgraded transport protocol, such as Internet Protocol (IP) or X.25. Regardless of the transport protocol, the logical connections between PSAP 106 and ALI databases 121-122 remain point-to-point dedicated connections 131-132.

To illustrate how communication network 100 operates, assume that a caller dials 9-1-1 or a similar emergency number on telephone 102. Selective router 104 receives the emergency call, such as through a central office (not shown), a tandem switch (not shown), etc. Selective router 104 also receives an Emergency Service Number (ESN) associated with the location of the calling party from one or more ALI databases 121-122 or from another database (not shown). In FIG. 1, based on the ESN, selective router 104 selects PSAP 106 to handle the call and routes the emergency call to PSAP 106. Networks may route the emergency call to PSAP 106 in different ways depending on the desired implementation. Some examples of different implementations are illustrated in U.S. Pat. No. 6,415,018, U.S. Pat. No. 6,584,307, U.S. Pat. No. 6,385,302, and U.S. Pat. No. 6,587,545, which are all incorporated herein by reference to the same extent as if fully set forth herein.

Emergency services network 108, which provides E9-1-1 services, includes Automatic Location Identification (ALI) services. When PSAP 106 receives the emergency call, PSAP 106 also receives an ANI for the call. The ANI, which is the telephone number of the calling party telephone 102, allows an operator in PSAP 106 to call the calling party back if the call happens to be terminated. The ANI also allows the PSAP 106 to fetch information on the physical location of the calling party in order to dispatch the appropriate emergency personnel (e.g., police, ambulance, fire department). To fetch the location information, PSAP 106 generates a request for the location information that includes the ANI of telephone 102, and forwards the request to ALI database 121 over dedicated connection 131. PSAP 106 may forward the request to ALI database 122 over dedicated connection 132 in addition to forwarding the request to ALI database 121 or instead of forwarding the request to ALI database 121.

ALI database 121 receives the request for location information that includes the ANI. ALI database 121 searches for location information corresponding with the ANI. If ALI database 121 finds location information corresponding with the ANI, then ALI database 121 responds to PSAP 106 with the location information. If ALI database 121 does not find location information corresponding with the ANI, then ALI database 121 may have to query other ALI databases or other databases or systems for the location information.

ALI database 121 acts as an intermediary between PSAP 106 and the other emergency services in emergency services network 108. PSAP 106 does not directly connect with emergency services other than ALI databases 121-122. PSAP 106 communicates with MPC 124 and supplemental information provider 128 through one or both of ALI databases 121-122. For instance, if telephone 102 is a mobile phone, then ALI database 121 queries MPC 124 or another MPC (not shown) for location information corresponding with the ANI and forwards the location information to PSAP 106. ALI database 121 may provide supplemental information provider 128 with the ANI, and supplemental information provide 128 may provide services such as notifying third parties of the emergency call. In each of these cases, ALI database 121 interfaces PSAP 106 with the other emergency services.

When PSAP 106 receives a response from ALI database 121, PSAP 106 should be better informed to handle the emergency call. For instance, PSAP 106 should have location information for the calling party. PSAP 106 then informs the appropriate emergency personnel of the emergency call so that the emergency personnel can be quickly dispatched.

One problem with current emergency services networks is that the PSAP-ALI interface uses dedicated point-to-point connections 131-132 between PSAP 106 and ALI databases 121-122. PSAP 106 is not able to dynamically connect with another ALI database (not shown) or another resource in emergency services network 108. PSAP 106 is dependant on the pair of ALI databases 121-122 to provide information for an emergency call. If one of the ALI databases 121 were to be taken out of service for maintenance or upgrades, then PSAP 106 would be connected to a single ALI database 122 and become one-sided. If the remaining ALI database 122 was to go out of service, then PSAP 106 would not be able to adequately service emergency calls. Emergency services administrators try to avoid architectures that rely on a single device or system because of the higher possibility of a service outage.

Another problem with current emergency services networks is the traditional PSAP-ALI interface uses a limited message set. Most conventional PSAPs fundamentally include the same design as when they were initially conceived in the 1970's. The conventional PSAPs are configured to receive a fixed-length, pre-defined text string. The fixed-length text string limits the number of fields and the size of the fields that can be included in the text string. The small size of the text stream severely constrains the amount of information that the ALI database can provide to the PSAP, the context that can be created, and the data types that can be supported. Emergency services administrators have had to “overload” the text string, using the same fixed-length field for multiple purposes in different contexts, to provide the current services. New services or new capabilities are very difficult to add if the text string is overloaded by the current services. For instance, an ALI database would not be able to provide or would only be able to provide very limited individual medical information to the PSAP. Also, the technology does not lend itself to streaming video to the PSAP as the traditional message set does not have the capacity.

Another problem with current emergency services networks is that the PSAP-ALI interface model is a request-response model. The PSAP forwards a request for ALI information to the ALI database, and the ALI database provides a response to the PSAP. Under the current model, the PSAP has to initiate communication with the ALI database with a request for ALI information. The ALI database is not allowed or equipped to initiate a communication with the PSAP, or deliver ALI information to the PSAP unless the PSAP submits a request. The current PSAP-ALI interface model limits the types of enhanced services provided by the emergency services network.

The following example illustrates some of the problems and limitations of the current emergency services networks. Assume that telephone 102 comprises a mobile telephone and that a user of telephone 102 dials 9-1-1. Selective router 104 routes the 9-1-1 call to PSAP 106. PSAP 106 submits a request to ALI database 121 for information for the 9-1-1 call. The request includes an ANI. Responsive to receiving the request, ALI database 121 determines that the ANI is a pseudo-ANI corresponding with a wireless service provider for telephone 102. The ANI is not the actual telephone number of telephone 102, but is a key corresponding with basic information identifying the wireless service provider and/or identifying the cell tower from which the 9-1-1 call originated.

Because the pseudo-ANI is for a wireless service provider, ALI database 121 does not have location information for the pseudo-ANI. Consequently, ALI database 121 cannot immediately provide the location information to PSAP 106 because it must attempt to retrieve location information for telephone 102. ALI database 121 retrieves the location information by submitting a request to the wireless service provider's MPC 124. Because the PSAP-ALI interface allows only one response to a request, ALI database 121 attempts to collect all call information before responding to PSAP 106. ALI database 121 also attempts to ensure that PSAP 106 receives a response within a reasonable amount of time. Before submitting the request to MPC 124, ALI database 121 sets a timer to indicate how long it will wait for MPC 124 to respond. If MPC 124 responds within the time period, then ALI database 121 responds to PSAP 106 with the location information on telephone 102. The location information may be approximate X, Y coordinates (longitude and latitude) of telephone 102 (assuming a wireless Phase II system).

If MPC 124 does not respond within the time period, then ALI database 121 responds to PSAP 106 with basic call information. The basic call information does not specify the location of telephone 102. The basic call information may merely be information on the wireless service provider or information on the cell tower from which the 9-1-1 call originated. If MPC 124 responds to ALI database 121 with the location information after ALI database 121 has already responded to PSAP 106 with the basic information, ALI database 121 cannot provide the location information on telephone 102 to PSAP 106. As previously stated, ALI database 121 cannot transmit information to PSAP 106 unless PSAP 106 has previously transmitted a request to ALI database 121 that remains unanswered. To obtain the location information from ALI database 121, PSAP 106 will have to submit another request to ALI database 121 for the same information (sometimes referred to as a re-bid).

If ALI database 121 receives another request from PSAP 106, then ALI database 121 will need to determine whether to send the previous location information received from MPC 124, request new location information from MPC 124, handle time-out scenarios, and handle situations where this request may be for a new 9-1-1 call using the same pseudo-ANI. This scenario is further complicated because the ALI database 121 does not know when this call ends and another call with the same pseudo-ANI begins. Thus, ALI database 121 uses an elaborate scheme of timers to determine if the information received from MPC 124 is stale, and determines whether it should return the information for subsequent requests from PSAP 106 or whether it should submit new requests to MPC 124. While ALI database 121 is requesting information from MPC 124 and PSAP 106 is waiting for a response, PSAP 106 may be connected with a calling party possibly engaged in a life or death situation where any bit of information might help determine the best course of action. ALI database 121 cannot tell that it takes more time to determine location information for telephone 102 because of technology overhead. PSAP 106 may have to wait 10 to 15 seconds to be told nothing more than that the 9-1-1 call is a wireless call.

The PSAP-ALI interface puts the PSAP operator in a guessing game. The PSAP operator does not know when the wireless call location information becomes available and does not know how often re-bids should be submitted to receive initial or new information. PSAP operators are taught not to push the re-bid button repeatedly in hopes of getting caller information, as this could have the opposite effect and swamp ALI database 121 or MPC 124 in a manner such that PSAP 106 cannot receive a response.

As is illustrated above, the current emergency services networks use old technology, are not very flexible in updating or improving existing services, and are not readily expandable to add new and better services. The importance of emergency services networks demands that these networks evolve to provide the best and most reliable services.

### DESCRIPTION OF THE INVENTION

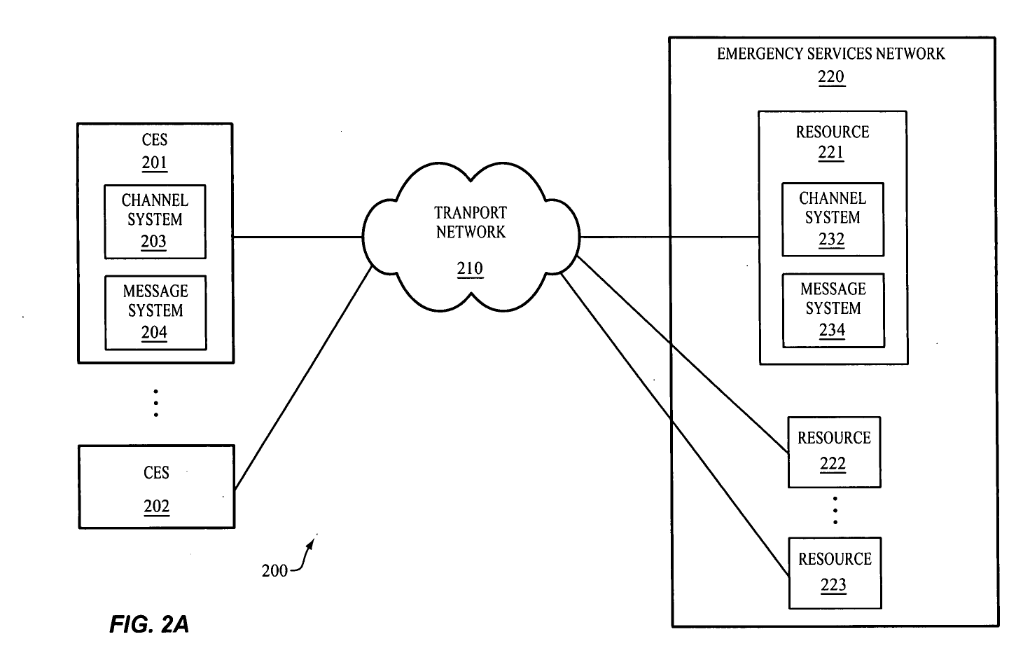

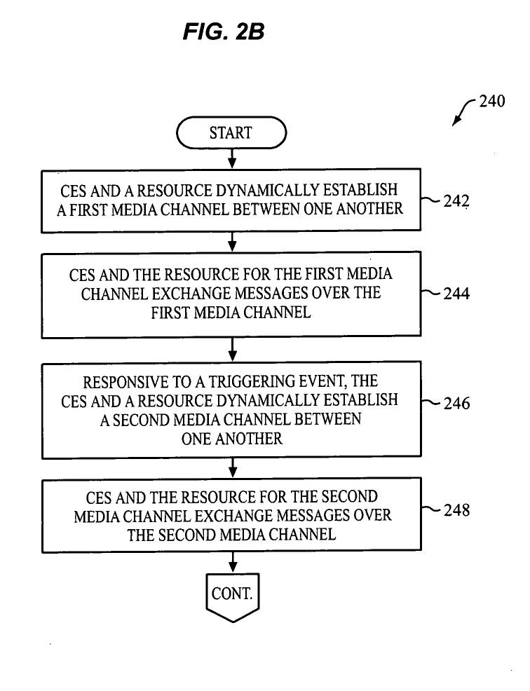

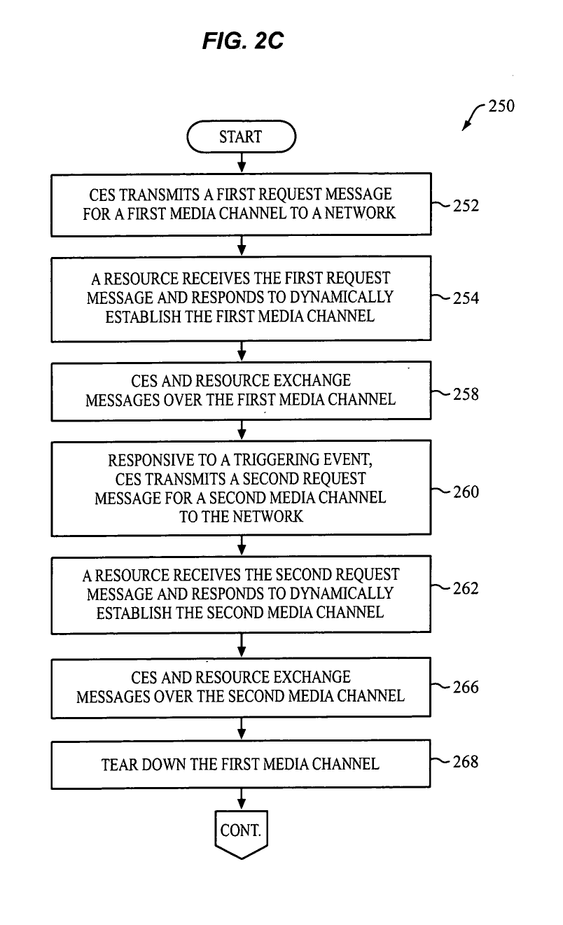

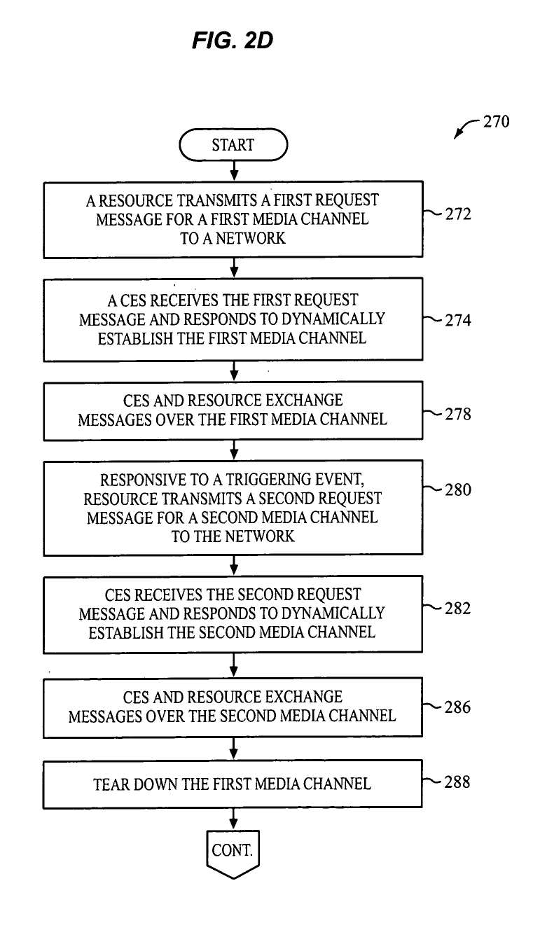

FIGS. 2A-2D, 3A-3C and 4-5 and the following description depict specific embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 2A illustrates a communication network 200 in an exemplary embodiment of the invention. Communication network 200 includes conforming emergency systems (CES) 201-202, a transport network 210, and an emergency services network 220. Emergency services network 220 includes a plurality of resources 221-223. CESs 201-202 and resources 221-223 are connected to network 210. Communication network 200 may include other devices, resources, or systems not shown in FIG. 2A for the sake of brevity. Emergency services network 220 may include many more resources in addition to the ones shown in FIG. 2A. FIG. 2A is intended to illustrate communication network 200 in a more functional manner than a physical manner.

A conforming emergency system comprises any system, device, or equipment configured to communicate according to the message set used by an emergency services network to access emergency services (not shown) to handle emergency events. One example of a conforming emergency system is a computer system for a Public Safety Answering Point (PSAP) conforming to the message set used by an emergency services network. A PSAP is known in the art of emergency services as a location where an emergency call (e.g., a 9-1-1 call) is answered. Another example of a conforming emergency system is a computer system for a hospital, a police department, a fire station, a fire alarm company, a security company, an ambulance service, a state 9-1-1 coordinator, the Federal Emergency Management Agency (FEMA), the Department of Homeland Security, the National Geophysical Data Center, the Center for Disease Control (CDC), etc, that conforms to the message set used by an emergency services network and is used to access in emergency services to handle emergency events. An emergency event comprises any instance or situation where a request for emergency services may be made. Examples of an emergency event include any abbreviated number call (e.g., a 9-1-1 call in the U.S., a 3-1-1 call in the U.S., and a 1-1-2 call in Europe), any call or request from a computer, a PDA, a TDD device, or any other device for emergency services, an email message, an SMS message, an Internet message, a call or signal to an emergency call center (e.g., an independent alarm service, OnStar®, etc), or any other request for emergency services.

A transport network in this embodiment comprises any connection(s), path(s), etc for supporting a media channel, such as a packet network, an Internet Protocol (IP) network, a frame relay network, an X.25 network, an Asynchronous Transfer Mode (ATM) network, wireless connections, satellite connections, wireline connections, etc. A resource comprises any system, device, equipment, or server configured to communicate with a conforming emergency system via a media channel over a transport network to facilitate the handling of emergency events. An example of a resource includes a response gateway. A media channel comprises any communication path or paths (logical, virtual, or otherwise) over a transport network configured to transport data such as streaming video, streaming audio, voice, graphics, text data, binary data, executable instructions or scripts, etc. A media channel is not a physical or logical point-to-point dedicated connection over a transport network. The media channel may transport control messages or may operate in conjunction with a separate control channel. A response gateway comprises any system or server configured to communicate with a conforming emergency system via a media channel over a packet network, and interface the conforming emergency system with emergency services of an emergency services network.

An emergency services network includes any network or networks that provide emergency services or facilitates a conforming emergency system in handling emergency events. Emergency services comprise any services subscribed to or provided for an emergency call or other event requiring such services. One example of an emergency service is an ALI database that provides location information. Another example of an emergency service is a Mobile Positioning Center (MPC) or a Gateway Mobile Location Center (GMLC) that provides location information for mobile devices. Another example of an emergency service is a Voice over Internet Protocol (VoIP) server or a selective transfer point determination system that provides location information for a VoIP phone or device. Another example of an emergency service is an Emergency Auxiliary Service Provider (EASP) or an Emergency Information Service that are general terms for any service provider that provides information or performs a function. For instance, an EASP may contain medical information for a subscriber and information on a subscriber's premises, such as a code to a front gate, guard dogs, hazardous materials, etc. The EASP may also include a third-party notification service that notifies third parties of an emergency event. The term “emergency service” is intended to include any accompanying structure that performs the emergency services, such as processing systems, computing platforms, network interfaces, servers, etc. Emergency services may be included in or as part of a resource and/or a resource may interface a conforming emergency system with a remote emergency service. In other words, a resource may also include an ALI database, an MPC, a GMLC, an EASP, a VoIP server, or any other emergency service.

FIG. 2B is a flow chart illustrating a method 240 for rotating media channels between a conforming emergency system (CES) 201 and one or more resources 221-223 of emergency services network 220 in an exemplary embodiment of the invention. Any reference to “first”, “second”, “third”, in this description or in the claims is to differentiate elements and messages, and is not intended to indicate sequence or timing. In step 242, CES 201 and one of the resources 221-223 (assume resource 221) in emergency services network 220 dynamically establish a first media channel between one another. In stating that CES 201 and resource 221 dynamically establish a first media channel, either one or both of CES 201 and resource 221 may initiate and/or facilitate the dynamic establishment of the first media channel. Another system may also assist in the dynamic establishment of the first media channel. CES 201 and resource 221 may use Session Initiation Protocol (SIP), H.323, Signaling System No. 7 (SS7), LAPD, Q.921, Q.931, or another comparable protocol or method for dynamically establishing a media channel. With the first media channel established, CES 201 and resource 221 may then exchange messages over the first media channel to facilitate CES 201 in handling emergency events, in step 244.

Responsive to a triggering event, CES 201 and one of the resources 221-223 (assume resource 222) in emergency services network 220 dynamically establish a second media channel between one another, in step 246. Although CES 201 and resource 222 dynamically establish the second media channel in this embodiment, CES 201 could dynamically establish the second media channel with resource 221 or resource 223 in other embodiments. With the second media channel established, CES 201 and resource 222 may then exchange messages over the second media channel to facilitate CES 201 in handling emergency events, in step 248.

The triggering event may vary depending on desired implementations. For instance, the triggering event may be a time period elapsing, or a request from CES 201, resources 221-223, or another system (not shown). Media channels may also be established for an individual emergency event. In that case, the triggering event would be CES 201 receiving a new emergency event to be handled. Other triggering events may be a load imbalance, a failure, taking a resource out of service, etc.

The first media channel may be torn down at some point. The first media channel may be torn down before the second media channel is established, after the second media channel is established, or simultaneously with the establishment of the second media channel. The first media channel should not be torn down while current message sessions or message transfers still exist over the first media channel. Therefore, the current message sessions over the first media channel may be allowed to end before the first media channel is torn down. In other embodiments, the current message sessions over the first media channel may be rolled onto the second media channel before the first media channel is torn down.

Method 240 continues to establish new media channels and tear down old media channels as described above to rotate the media channels. For instance, method 240 may continue so that, responsive to subsequent triggering events, CES 201 and one of the resources 221-223 establish a third media channel, a fourth media channel, etc.

CES 201 and resources 221-223 may dynamically establish media channels in different ways depending on the desired implementation. FIGS. 2C and 2D and the following description illustrate two methods of dynamically establishing and rotating media channels.

FIG. 2C is a flow chart illustrating a method 250 for rotating media channels between conforming emergency systems (CES) 201-202 and resources 221-223 of emergency services network 220 in an exemplary embodiment of the invention. In step 252, a conforming emergency system (assume CES 201) transmits a first request message for a first media channel to network 210. One of the resources 221-223 (assume resource 221) in emergency services network 220 receives the first request message, in step 254. CES 201, resource 221, or another system may include selection logic (not shown) or an algorithm for selecting resource 221. Also in step 254, resource 221 responds to the first request message to dynamically establish the first media channel between CES 201 and resource 221. CES 201 and resource 221 may then exchange messages over the first media channel to facilitate CES 201 in handling emergency events, in step 258.

In responding to the first request message, resource 221 may transmit a first response message to network 210. The first response message indicates an acceptance of the first media channel, indicates the acceptance of parameters of the first media channel, or otherwise indicates that resource 221 is available and capable of handling the first media channel. Resource 221 may also negotiate parameters of the first media channel before transmitting the first response message. Responsive to receiving the first response message, CES 201 initiates a process to dynamically establish the first media channel between CES 201 and resource 221. One example of a process initiated by CES 201 is setting up a Secure Sockets Layer (SSL) TCP/IP interface. In this embodiment, CES 201 may transmit the first request message directly to resource 221 or to another system. Similarly, resource 221 may transmit the first response message directly to CES 201 or to another system.

Alternatively, in responding to the first request message, resource 221 may initiate a process to dynamically establish the first media channel between CES 201 and resource 221. One example of a process initiated by resource 221 is setting up a Secure Sockets Layer (SSL) TCP/IP interface.

In step 260, responsive to a triggering event, CES 201 transmits a second request message for a second media channel to network 210. One of the resources 221-223 (assume resource 222) in emergency services network 220 receives the second request message, in step 262. Although resource 222 receives the second request message in this embodiment, resource 221 or resource 223 could receive the second request message in other embodiments. Also in step 262, resource 222 responds to the second request message to dynamically establish the second media channel between CES 201 and resource 222. CES 201 and resource 222 may then exchange messages over the second media channel to facilitate CES 201 in handling emergency events, in step 266.

In responding to the second request message, resource 222 may transmit a second response message to network 210. The second response message indicates an acceptance of the second media channel, indicates the acceptance of parameters of the second media channel, or otherwise indicates that resource 222 is available and capable of handling the second media channel. Resource 222 may also negotiate parameters of the second media channel before transmitting the second response message. Responsive to receiving the second response message, CES 201 initiates a process to dynamically establish the second media channel between CES 201 and resource 222.

Alternatively, in responding to the second request message, resource 222 may initiate a process to dynamically establish the second media channel between CES 201 and resource 222. One example of a process initiated by resource 222 is setting up a Secure Sockets Layer (SSL) TCP/IP interface.

Method 250 continues to establish new media channels and tear down old media channels as described above to rotate the media channels.

FIG. 2D is a flow chart illustrating another method 270 for rotating media channels between conforming emergency systems 201-202 and resources 221-223 in an exemplary embodiment of the invention. In step 272, one of the resources 221-223 (assume resource 221) transmits a first request message for a first media channel to network 210. A conforming emergency system (assume CES 201) receives the first request message, in step 274. Also in step 274, CES 201 responds to the first request message to dynamically establish the first media channel between CES 201 and resource 221. CES 201 and resource 221 may then exchange messages over the first media channel to facilitate CES 201 in handling emergency events, in step 278.

In responding to the first request message, CES 201 may transmit a first response message to network 210. The first response message indicates an acceptance of the first media channel, indicates the acceptance of parameters of the first media channel, or otherwise indicates that the CES 201 is available and capable of handling the first media channel. CES 201 may also negotiate parameters of the first media channel before transmitting the first response message. Responsive to receiving the first response message, resource 221 initiates a process to dynamically establish the first media channel between resource 221 and CES 201. In this embodiment, resource 221 may transmit the first request message directly to CES 201 or to another system. Similarly, CES 201 may transmit the first response message directly to resource 221 or to another system.

Alternatively, in responding to the first request message, CES 201 may initiate a process to dynamically establish the first media channel between CES 201 and resource 221. One example of a process initiated by CES 201 is setting up a Secure Sockets Layer (SSL) TCP/IP interface.

In step 280, responsive to a triggering event, resource 221 transmits a second request message for a second media channel to network 210. CES 201 receives the second request message, in step 282. Also in step 282, CES 201 responds to the second request message to dynamically establish the second media channel between CES 201 and resource 221. CES 201 and resource 221 may then exchange messages over the second media channel to facilitate CES 201 in handling emergency events, in step 286.

In responding to the second request message, CES 201 may transmit a second response message to network 210. The second response message indicates an acceptance of the second media channel, indicates the acceptance of parameters of the second media channel, or otherwise indicates that CES 201 is available and capable of handling the second media channel. CES 201 may also negotiate parameters of the second media channel before transmitting the second response message. Responsive to receiving the second response message, resource 221 initiates a process to dynamically establish the second media channel between resource 221 and CES 201.

Alternatively, in responding to the second request message, CES 201 may initiate a process to dynamically establish the second media channel between CES 201 and resource 221. One example of a process initiated by CES 201 is setting up a Secure Sockets Layer (SSL) TCP/IP interface.

The first media channel may be torn down at some point in step 288. The first media channel may be torn down before the second media channel is established, after the second media channel is established, or simultaneously with the establishment of the second media channel. The first media channel should not be torn down while current message sessions or message transfers still exist on the first media channel. Therefore, the current message sessions over the first media channel may be allowed to end before the first media channel is torn down. In other embodiments, the current message sessions over the first media channel may be rolled onto the second media channel before the first media channel is torn down.

FIG. 2A also illustrates the configuration of CES 201 and resource 221 in communication network 200 in an exemplary embodiment of the invention. CES 201 includes a channel system 203 and a message system 204. Similarly, resource 221 includes a channel system 232 and a message system 234. CES 202 may have a similar configuration to CES 201. Resources 222-223 may have a similar configuration to resource 221. Channel system 203 and message system 204 are not necessarily two separate components, processors, devices, etc., but represent two functionalities that may be performed on a single system or multiple systems. For instance, channel system 203 and message system 204 may each represent a piece of software code being executed on a common processing system. The same rational applies for channel system 232 and message system 234. CES 201 and resource 221 may include other devices, components, or systems not shown in FIG. 2A for the sake of brevity.

Channels systems 203 and 232 are configured to setup up a media channel between CES 201 and resource 221. Referring to method 240, channel system 203 of CES 201 and channel system 232 of resource 221 dynamically establish the first media channel between CES 201 and resource 221. An example of channel systems 203 and 232 is a SIP user agent. Message systems 204 and 234 are configured to exchange messages over an established media channel. Thus, when the first media channel is established between CES 201 and resource 221, message system 204 and message system 234 exchange messages and/or information over the first media channel. Responsive to a triggering event, channel system 203 and channel system 232 dynamically establish the second media channel between CES 201 and resource 221. When the second media channel is established between CES 201 and resource 221, message system 204 and message system 234 exchange messages and/or information over the second media channel.

Channel systems 203 and 232 and message systems 204 and 234 may be comprised of instructions that are stored on storage media (not shown). The instructions can be retrieved and executed by a processor (not shown). Some examples of instructions are software, program code, and firmware. Some examples of storage media are memory devices, tape, disks, integrated circuits, and servers. The instructions are operational when executed by the processor to direct the processor to operate in accord with the invention. The term “processor” refers to a single processing device or a group of inter-operational processing devices. Some examples of processors are computers, integrated circuits, and logic circuitry. Those skilled in the art are familiar with instructions, processors, and storage media.

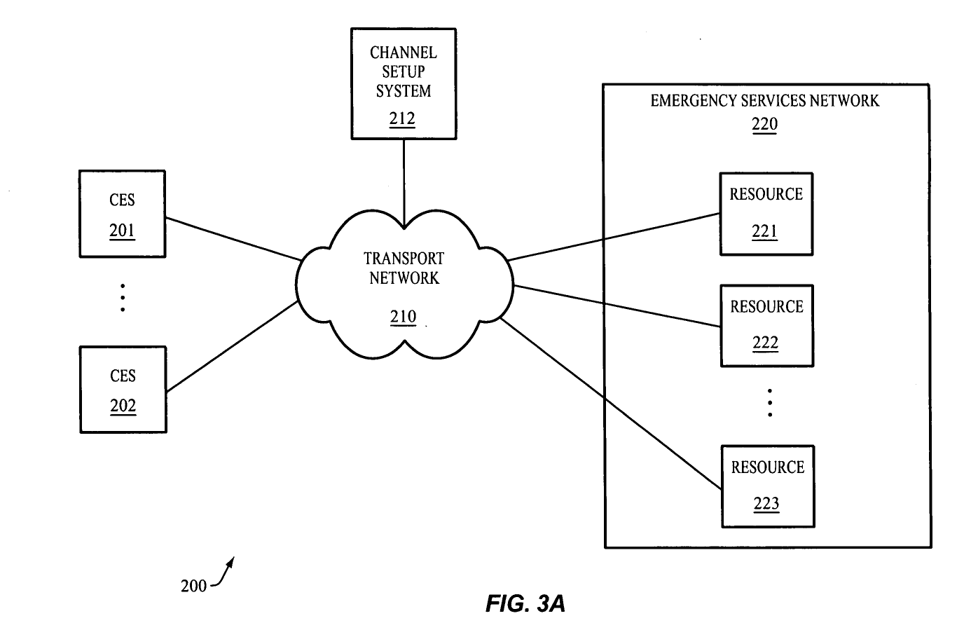

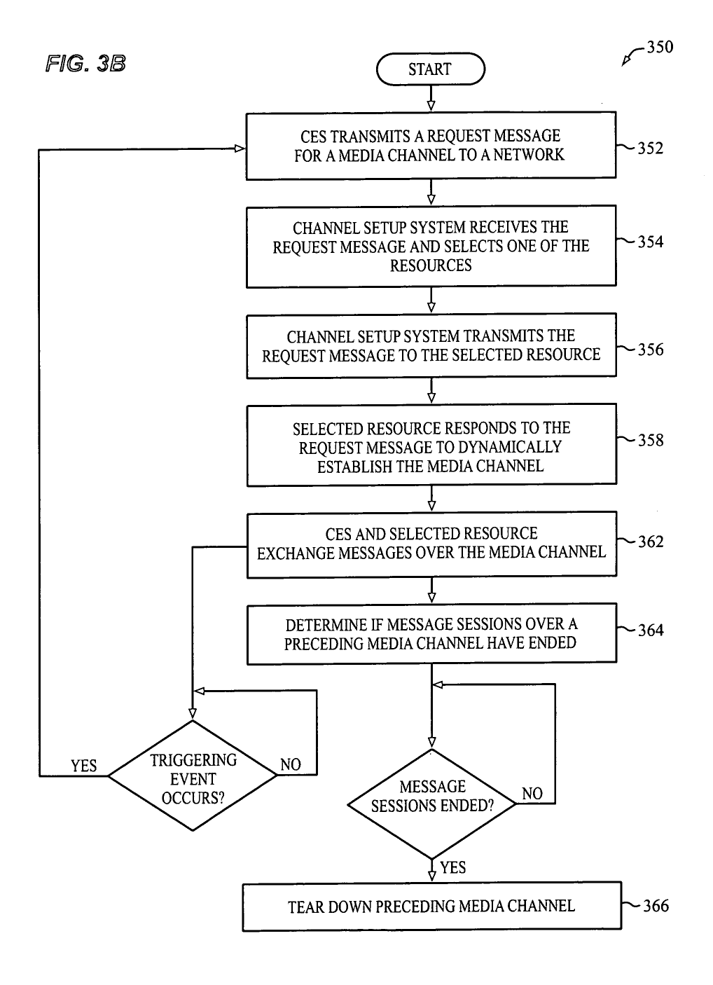

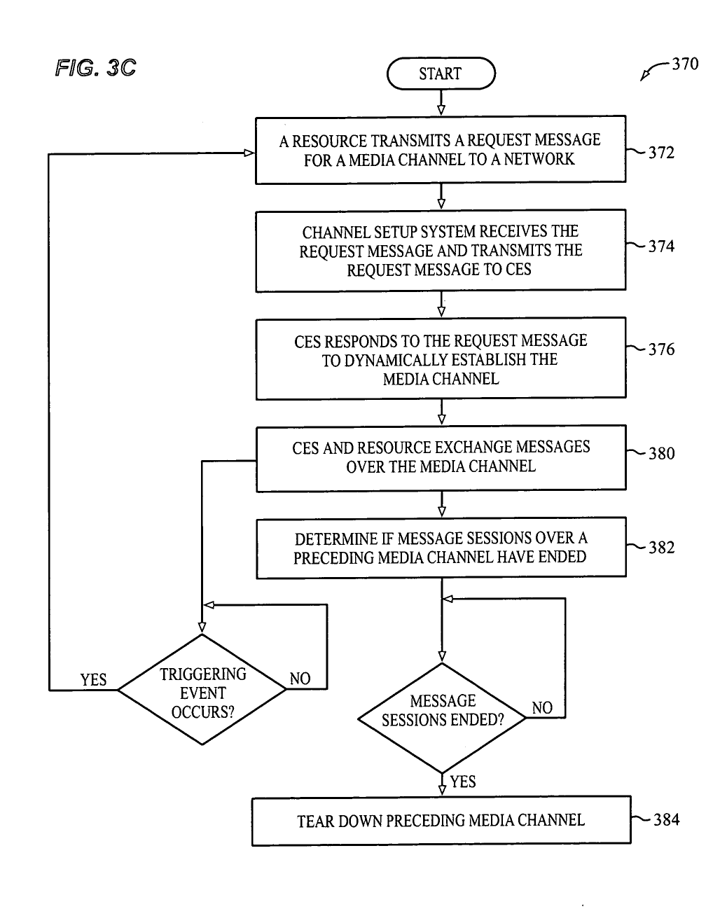

FIG. 3A illustrates communication network 200 further including a channel setup system 212 in an exemplary embodiment of the invention. Channel setup system 212 is connected to network 210. Channel setup system 212 comprises any system or server configured to assist in the setup of a media channel over network 210. Examples of channel setup system 212 include a Session Initiation Protocol (SIP) server and a SIP proxy.

FIG. 3B is a flow chart illustrating a method 350 for using channel setup system 212 to rotate media channels between conforming emergency systems 201-202 and resources 221-223 in an exemplary embodiment of the invention. In step 352, a conforming emergency system (CES 201) transmits a request message for a media channel to network 210. Channel setup system 212 receives the request message for the media channel and selects one of the resources 221-223 (assume resource 221) in emergency services network 220 with which to establish the media channel, in step 354. Channel setup system 212 may include selection logic (not shown) or an algorithm for selecting one of the resources 221-223. Channel setup system 212 then transmits the request message for the media channel to the selected resource 221 in step 356.

The selected resource 221 in emergency services network 220 receives the request message. Responsive to receiving the request message, the selected resource 221 responds to the request message to dynamically establish the media channel between the CES 201 and the selected resource 221, in step 358.

In responding to the request message, the selected resource 221 may transmit a response message to network 210. The response message indicates an acceptance of the media channel, indicates the acceptance of parameters of the media channel, or otherwise indicates that the selected resource 221 is available and capable of handling the media channel. The selected resource 221 may also negotiate parameters of the media channel before transmitting the response message. In transmitting the response message to network 210, the selected resource 221 may transmit the response message directly to CES 201. Alternatively, the selected resource 221 may transmit the response message to channel setup system 212, and channel setup system 212 transmits the response message to CES 201. Responsive to receiving the response message, CES 201 initiates a process to dynamically establish the media channel. One example of a process initiated by CES 201 is setting up a Secure Sockets Layer (SSL) TCP/IP interface.

Alternatively, in responding to the request message, the selected resource 221 may initiate a process to dynamically establish the media channel between CES 201 and the selected resource 221. One example of a process initiated by the selected resource 221 is setting up a Secure Sockets Layer (SSL) TCP/IP interface.

In step 362, CES 201 and the selected resource 221 may then exchange messages over the media channel to facilitate CES 201 in handling emergency events. In step 364, CES 201, channel setup system 212, and/or the selected resource 221 determine if message sessions over a preceding media channel have ended. Before the establishment of the media channel in step 358, CES 201 and a resource 221-223 in emergency services network 220 were exchanging messages over another, preceding media channel. CES 201 and the resource 221-223 may have on-going message sessions over that media channel when the new media channel is established in step 358. CES 201, channel setup system 212, and/or the selected resource 221 cease to establish new message sessions over that media channel and determine if message sessions over that media channel have ended. If the message sessions have ended, then CES 201, channel setup system 212, and/or the selected resource 221 tear down the preceding media channel in step 366. If the message sessions have not ended, then CES 201, channel setup system 212, and/or the selected resource 221 may wait for the message sessions to end or roll the message sessions onto the new media channel.

CES 201, channel setup system 212, and/or the selected resource 221 also determine if a triggering event has occurred. If the triggering event occurs, then method 350 returns to step 352. Method 350 continues so that media channels are rotated. The order in which a media channel is established with a resource 221-223 depends on the selection made by channel setup system 212. CES 201 may establish a media channel with the same resource consecutively according to method 350, as multiple media channels may be established with the same resource.

CES 201, channel setup system 212, and resource 221 may use Session Initiation Protocol (SIP), H.323, Signaling System No. 7 (SS7), LAPD, Q.921, Q.931, or another comparable protocol or method for dynamically establishing a media channel. Channel setup system 212 may comprise a SIP proxy or a SIP server.

FIG. 3C is a flow chart illustrating another method 370 for using channel setup system 212 to rotate media channels between conforming emergency systems 201-202 and resources 221-223 in an exemplary embodiment of the invention. In step 372, one of the resources 221-223 (assume resource 221) transmits a request message for a media channel to network 210. Channel setup system 212 receives the request message for the media channel and transmits the request message for the media channel to CES 201 in step 374.

CES 201 receives the request message. Responsive to receiving the request message, CES 201 responds to the request message to dynamically establish the media channel between CES 201 and resource 221 in step 376.

In responding to the request message, CES 201 may transmit a response message to network 210. The response message indicates an acceptance of the media channel, indicates the acceptance of parameters of the media channel, or otherwise indicates that CES 201 is available and capable of handling the media channel. CES 201 may also negotiate parameters of the media channel before transmitting the response message. In transmitting the response message to network 210, CES 201 may transmit the response message directly to resource 221. Alternatively, CES 201 may transmit the response message to channel setup system 212, and channel setup system 212 transmits the response message to resource 221. Responsive to receiving the response message, resource 221 initiates a process to dynamically establish the media channel. One example of a process initiated by resource 221 is setting up a Secure Sockets Layer (SSL) TCP/IP interface.

Alternatively, in responding to the request message, CES 201 may initiate a process to dynamically establish the media channel between CES 201 and resource 221. One example of a process initiated by CES 201 is setting up a Secure Sockets Layer (SSL) TCP/IP interface.

In step 380, CES 201 and resource 221 may then exchange messages over the media channel to facilitate CES 201 in handling emergency events. In step 382, CES 201, channel setup system 212, and/or resource 221 determine if message sessions over a preceding media channel have ended. Before the establishment of the media channel in step 376, CES 201 and a resource 221-223 in emergency services network 220 were exchanging messages over another, preceding media channel. CES 201 and the resource 221-223 may have on-going message sessions over that media channel when the new media channel is established in step 376. CES 201, channel setup system 212, and/or resource 221 cease to establish new message sessions over that media channel and determine if message sessions over that media channel have ended. If the message sessions have ended, then CES 201, channel setup system 212, and/or resource 221 tear down the preceding media channel in step 384. If the message sessions have not ended, then CES 201, channel setup system 212, and/or the selected resource 221 may wait for the message sessions to end or roll the message sessions onto the new media channel.

CES 201, channel setup system 212, and/or resource 221 also determine if a triggering event has occurred. If the triggering event occurs, then method 370 returns to step 372. Method 370 continues so that media channels are rotated. CES 201 may establish a media channel with the same resource consecutively according to method 370, as multiple media channels may be established with the same resource.

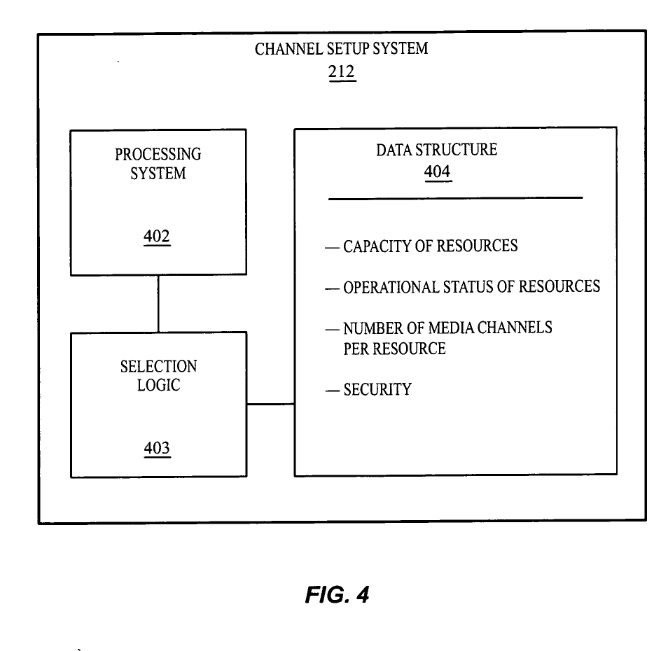

FIG. 4 illustrates channel setup system 212 in an exemplary embodiment of the invention. Channel setup system 212 includes a processor 402, selection logic 403, and a data structure 404. Data structure 404 includes information on resources 221-223 of emergency services network 220, information on routing messages to systems connected to network 210, and other information and data. For instance, data structure 404 may include information on the capacity or current load of each resource 221-223, information on the operational status of each resource (e.g., in service/out of service), information on the number of media channels per resource 221-223, information on security, information on the location of each resource 221-223, information on the data connectivity speed of each resource 221-223, information on the type of protocol used by each resource 221-223, information on the type of resource 221-223, etc. Data structure 404 may include much more information than that which is described. Each resource 221-223 may update channel setup system 212 as to information on that resource.

When in operation, channel setup system 212 receives a request message for a media channel. Responsive to the request message, processor 402 executes selection logic 403 to selects one of the resources 221-223 in emergency services network 220 with which to establish the media channel. Selection logic 403 may identify the availability of each of the resources 221-223 in making the selection. For instance, in making the selection, selection logic 403 accesses data structure 404 for information on the individual resources. If resource 222 is at 90% of its capacity and resource 221 is a 10% of its capacity, then selection logic 403 may select resource 221. If resource 223 has failed or has been taken out of service for maintenance, then selection logic 403 will not select resource 223. If resources 222-223 are each currently serving one media channel and resource 221 is not serving any media channels, then selection logic 403 may select resource 221 to balance out the media channels between the resources 221-223. When selection logic 403 selects one of the resources 221-223, channel setup system 212 transmits the request message for the media channel to the selected resource.

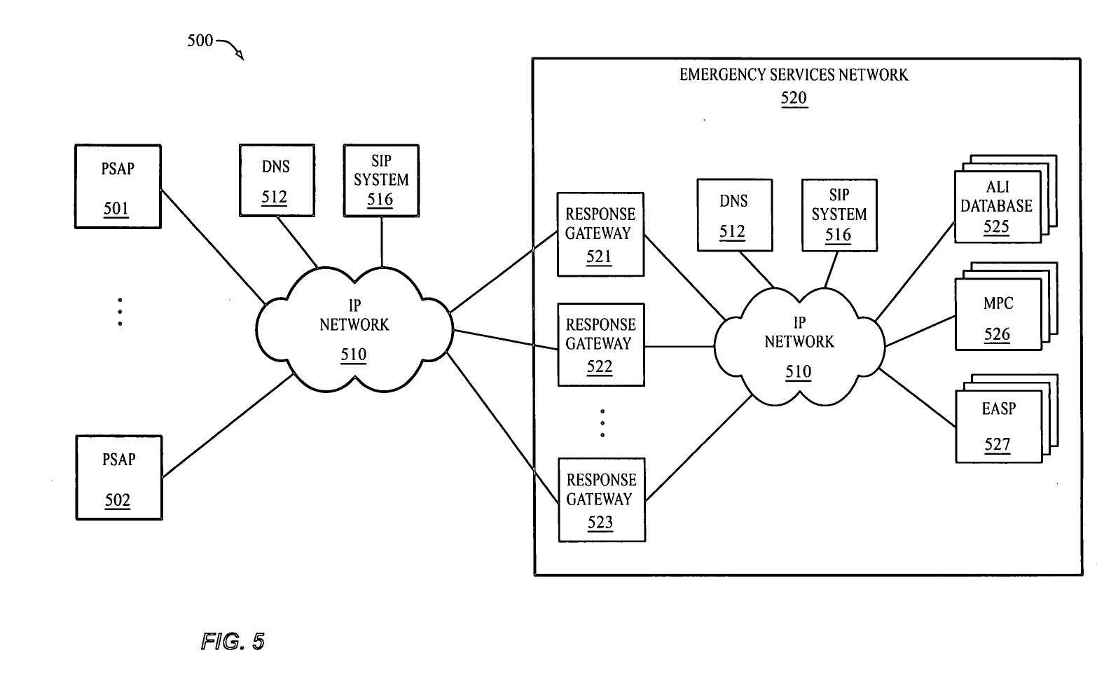

FIG. 5 illustrates another communication network 500 in an exemplary embodiment of the invention. Communication network 500 includes a plurality of PSAPs 501-502, an Internet Protocol (IP) network 510, a Domain Name Server (DNS) 512, a Session Initiation Protocol (SIP) system 516, and an emergency services network 520. Emergency services network 520 includes a plurality of response gateways 521-523, ALI databases 525, Mobile Positioning Centers (MPC) 526, and Emergency Auxiliary Service Providers (EASP) 527. PSAPs 501-502, DNS 512, SIP system 516, response gateways 521-523, ALI databases 525, MPCs 526, and EASPs 527 are connected to network 510. Communication network 500 may include other devices, resources, or systems not shown in FIG. 5 for the sake of brevity.

Domain name server 512 is known in the art as a system that resolves host names into IP addresses. SIP system 516 comprises any system that uses SIP to assist in dynamically establishing a media channel. Examples of SIP system 516 include a SIP proxy and a SIP server. ALI database 525 (may also be referred to as an ALI system or ALI server) is known in the art of emergency services as a system that provides information on the location of a calling party station (e.g., phone). MPC 526 is known in the art of emergency services as a system that provides information on the location of a mobile calling device (e.g., cell phone). EASP 527 comprises any emergency service configured to provide additional information for an emergency event, such as medical information, information on a subscriber's premises (e.g., guard dogs, hazardous materials, codes for a gate, etc), notify third parties of an emergency event, or provide any other services for an emergency services network.

When in operation, PSAP 501 initiates setup of a media channel with a response gateway 521-523. PSAP 501 uses SIP to initiate the setup of the media channel. PSAP 501 generates an Invite message and transmits the Invite message over a TCP/IP connection to IP network 510. The TCP/IP connection may be a secure connection. The Invite message may include a host address, such as “RG@EmergProvider.com”. IP network 510 transmits the host address to DNS 512. DNS 512 resolves the host address in the Invite message to an IP address for SIP system 516, and IP network 510 transmits the Invite message to SIP system 516.

Responsive to receiving the Invite message, SIP system 516 determines which of the response gateways 521-523 to select. SIP system 516 may include selection logic (not shown) that is able to intelligently select a response gateway 521-523 based on information on the response gateways. Response gateways 521-523 may periodically update SIP system 516 with information on capacity, operational status, etc. SIP system 516 may also query other systems (not shown) having selection logic.

SIP system 516 selects one of the response gateways 521-523 (assume response gateway 521 is selected). SIP system 516 identifies an IP address of the selected response gateway 521 and transmits the Invite message over IP network 510 to the IP address of the selected response gateway 521.

Response gateway 521 receives the Invite message from SIP system 516 along with an IP address of PSAP 501. Response gateway 521 may authenticate PSAP 501 via a login and password, via a Public Key Infrastructure (PKI) exchange of digital signatures, via public key cryptography, etc. Response gateway 521 may also access the PSAP's authorization to determine specific services available and subscribed to by PSAP 501. Response gateway 521 negotiates with PSAP 501 or SIP system 516 regarding parameters associated with the media channel to be established. Response gateway 521 may use another protocol to facilitate the negotiation of the appropriate protocol or parameters related to the media channel, such as Session Description Protocol (SDP). SDP may be carried within SIP messages to facilitate the establishment of a media channel, the version of the protocol, or parameters associated with the media channel. SDP is one way that two end-points request a media channel and agree upon the nature of the media channel. If response gateway 521 and PSAP 501 agree on the parameters for the media channel, then response gateway 521 transmits an OK message to PSAP 501. PSAP 501 receives the OK message and initiates a process to dynamically establish the media channel. An example of initiating a process is setting up a Secure Sockets Layer (SSL) TCP/IP interface.

SIP system 516 may broker any messages or negotiations between response gateway 521 and PSAP 501 instead of response gateway 521 and PSAP 501 communicating directly.

If the selected response gateway 521 is not able to accept the media channel, then SIP system 516 or another device transmits the Invite message to another response gateway 522-523. The Invite message is transmitted to response gateways 522-523 until a response gateway is found that can accept the media channel.

With the media channel established, PSAP 501 and response gateway 521 may exchange messages over the media channel to help PSAP 501 handle emergency calls. In many cases, PSAP 501 will multiplex multiple messages over the media channel. PSAP 501 and response gateway 521 may use any compatible transport protocol, such as TCP/IP, HTTP, XML, and RTP. PSAP 501 and response gateway 521 may encrypt any transmitted messages for security purposes. There may be multiple media channels established between PSAP 501 and response gateway 521.

The function of response gateway 521 is to interface PSAP 501 with emergency services in emergency services network 520. Thus, PSAP 501 transmits a message to response gateway 521 that includes an ANI for an emergency call. In other embodiments, a key or identifier other than an ANI may be used, such as a SIP address, a URI, etc. Based on the ANI, response gateway 521 determines which emergency services in emergency services network 520 have information corresponding with the ANI of the emergency call and the services with which the ANI is associated, such as by subscription. Response gateway 521 may query individual emergency services, such as ALI database 525, EASP 527, etc, to see if they have information corresponding with the ANI. To “correspond with” in this embodiment means that an emergency service has information on an ANI or that a subscriber has subscribed to an emergency service using that ANI. Response gateway 521 may know which emergency services to contact based on the ANI or other information provided by PSAP 501. For instance, response gateway 521 may know that an emergency call originated from a wireless device, so response gateway 521 knows to query MPC 526.

Response gateway 521 may also query a global server (not shown) that indicates which emergency services, such as ALI database 525, EASP 527, etc, correspond with the ANI. The emergency services would have to register the ANIs for which they correspond with the global server.

Response gateway 521 then obtains information on the emergency call from the identified emergency services. For example, assume that ALI database 525 and EASP 527 have information on the ANI for the emergency call received by PSAP 501. Response gateway 521 receives the information on the ANI from ALI database 525. Response gateway 521 may use SIP system 516 to establish the media channel as previously described. The media channel with ALI database 525 may be pre-established or established in response to the query to ALI database 525. Response gateway 521 also receives information on the ANI from EASP 527. Response gateway 521 may use SIP system 516 to establish the media channel as previously described. The media channel with EASP 527 may be pre-established or established in response to the query to EASP 527.

Response gateway 521 then transmits the information on the ANI to PSAP 501 over the media channel between PSAP 501 and response gateway 521. PSAP 501 receives the information on the emergency call, and uses the information to handle the emergency call. For instance, PSAP 501 may use the information on the emergency call to better decide which emergency personnel to inform and/or dispatch.

After a triggering event, PSAP 501 needs to establish a new media channel. Assume for this embodiment that the media channels are set to periodically rotate. Thus, a time period is designated and the triggering event occurs when the time period elapses. In other embodiments, any desired triggering event may be used. There may be multiple triggering events used.

When the time period elapses, PSAP 501 generates an Invite message for the new media channel and transmits the Invite message to IP network 510. Responsive to receiving the Invite message, SIP system 516 determines which of the response gateways 521-523 to select. SIP system 516 selects one of the response gateways 521-523 (assume response gateway 522). SIP system 516 identifies an IP address of the selected response gateway 522 and transmits the Invite message over IP network 510 to the IP address of response gateway 522.

Response gateway 522 receives the Invite message from SIP system 516 along with an IP address of PSAP 501. Response gateway 522 negotiates with PSAP 501 regarding parameters associated with the new media channel. If response gateway 522 and PSAP 501 agree on the parameters for the new media channel, then response gateway 522 transmits an OK message to IP network 510. Response gateway 522 may transmit the OK message to SIP system 516 or to PSAP 501 directly. PSAP 501 receives the OK message and initiates a process to dynamically establish the new media channel. With the new media channel established, PSAP 501 and response gateway 521 may exchange messages over the new media channel. PSAP 501 stops initiating new message sessions over the old media channel and waits until current message sessions over the old media channel have ended. When all message sessions have ended on the old media channel, PSAP 501 or another system tears down the old media session.

In conclusion, the embodiments of the invention described herein illustrate that rotating media channels between a PSAP and resources of an emergency services network provides many advantages over the prior art.

1. A communication network for rotating media channels between resources of an emergency services network and conforming emergency systems, the communication network comprising:
a conforming emergency system (CES) connected to a transport network; and
a plurality of resources of an emergency services network connected to the transport network,
wherein the CES and one of the resources dynamically establish a first media channel between one another over the transport network, and exchange messages over the first media channel to facilitate the CES in handling emergency events;
responsive to a triggering event, the CES and one of the resources dynamically establish a second media channel between one another over the transport network, and exchange messages over the second media channel to facilitate the CES in handling emergency events.

2. The communication network of claim 1 wherein the one resource for the first media channel and the one resource for the second media channel comprise the same resource.

3. The communication network of claim 1 wherein the one resource for the first media channel and the one resource for the second media channel comprise a different resource.

4. The communication network of claim 1 wherein:
at least one of the CES and the one resource for the first media channel tears down the first media channel after the second media channel is established.

5. The communication network of claim 1 wherein:
at least one of the CES and the one resource for the first media channel tears down the first media channel simultaneously as the second media channel is established.

6. The communication network of claim 1 wherein:
at least one of the CES and the one resource for the first media channel tears down the first media channel before the second media channel is established.

7. The communication network of claim 1 wherein:
at least one of the CES and the one resource for the first media channel tears down the first media channel after message sessions on the first media channel have ended.

8. The communication network of claim 1 wherein:
at least one of the CES and the one resource for the first media channel rolls message sessions on the first media channel to the second media channel before tearing down the first media channel.

9. The communication network of claim 1 wherein the triggering event comprises a time period elapsing.

10. The communication network of claim 1 wherein the triggering event comprises a request from the CES, the one resource for the first media channel, the one resource for the second media channel, or another system.

11. The communication network of claim 1 wherein the triggering event comprises the CES receiving a new emergency event.

12. The communication network of claim 1 wherein:
the CES transmits a first request message for the first media channel to the transport network;
the one resource for the first media channel receives the first request message, and responds to the first request message to dynamically establish the first media channel between the CES and the one resource for the first media channel;
responsive to the triggering event, the CES transmits a second request message for the second media channel to the transport network; and
the one resource for the second media channel receives the second request message, and responds to the second request message to dynamically establish the second media channel between the CES and the one resource for the second media channel.

13. The communication network of claim 12 wherein:
the one resource for the first media channel responds to the first request message by transmitting a response message indicating an acceptance of the first media channel to the transport network; and
the CES receives the response message over the transport network and initiates a process to dynamically establish the first media channel.

14. The communication network of claim 12 wherein:
the one resource for the first media channel responds to the first request message by initiating a process to dynamically establish the first media channel.

15. The communication network of claim 12 further comprising:
a channel setup system connected to the transport network, the channel setup system receives the first request message from the CES, selects the one resource for the first media channel, and transmits the first request message to the one resource for the first media channel.

16. The communication network of claim 15 wherein:
the channel setup system selects the one resource for the first media channel by identifying the availability of each of the resources in the emergency services network.

17. The communication network of claim 15 wherein:
the channel setup system includes a data structure that stores information on the plurality of resources, the channel setup system accesses the information in the data structure to select the one resource for the first media channel.

18. The communication network of claim 17 wherein the information in the data structure includes at least one of a capacity or current load of each of the plurality of resources, an operational status of each of the plurality of resources, a number of media channels established with each of the plurality of resources, security, a location of each resource, data connectivity speed of each resource, the type of protocol used by each resource, and the type of each resource.

19. The communication network of claim 15 wherein the channel setup system comprises a Session Initiation Protocol (SIP) proxy or a SIP server.

20. The communication network of claim 15 wherein:
the one resource for the first media channel responds to the first request message by transmitting a response message indicating an acceptance of the first media channel to the channel setup system; and
the channel setup system transmits the response message to the CES.

21. The communication network of claim 15 wherein:
the one resource for the first media channel responds to the first request message by transmitting a response message indicating an acceptance of the first media channel to the CES.

22. The communication network of claim 1 wherein:
the one resource for the first media channel transmits a first request message for the first media channel to the transport network;
the CES receives the first request message, and responds to the first request message to dynamically establish the first media channel between the CES and the one resource for the first media channel;
responsive to the triggering event, the one resource for the second media channel transmits a second request message for the second media channel to the transport network; and
the CES receives the second request message, and responds to the second request message to dynamically establish the second media channel between the CES and the one resource for the second media channel.

23. The communication network of claim 22 wherein:
the CES responds to the first request message by transmitting a response message indicating an acceptance of the first media channel to the transport network; and
the one resource for the first media channel receives the response message over the transport network and initiates a process to dynamically establish the first media channel.

24. The communication network of claim 22 wherein:
the CES responds to the first request message by initiating a process to dynamically establish the first media channel.

25. The communication network of claim 22 further comprising:
a channel setup system connected to the transport network, the channel setup system receives the first request message from the one resource for the first media channel, and transmits the first request message to the CES.

26. The communication network of claim 25 wherein the channel setup system comprises a Session Initiation Protocol (SIP) proxy or a SIP server.

27. The communication network of claim 25 wherein:
the CES responds to the first request message by transmitting a response message indicating an acceptance of the first media channel to the channel setup system; and
the channel setup system transmits the response message to the one resource for the first media channel.

28. The communication network of claim 25 wherein:
the CES responds to the first request message by transmitting a response message indicating an acceptance of the first media channel to the one resource for the first media channel.

29. The communication network of claim 1 wherein the CES and the one resource for the first media channel use Session Initiation Protocol (SIP) to dynamically establish the first media channel.

30. The communication network of claim 1 wherein the plurality of resources includes a response gateway.

31. The communication network of claim 1 wherein the plurality of resources includes at least one of an ALI database, a Mobile Positioning Center (MPC), a Gateway Mobile Location Center (GMLC), an Emergency Auxiliary Service Provider (EASP), and a Voice over Internet Protocol (VoIP) server.

32. The communication network of claim 1 wherein the emergency events include 9-1-1 calls.

33. The communication network of claim 1 wherein the CES exchanges at least one of streaming video, streaming audio, graphics data, voice, text or binary data, and executable instructions or scripts over the first media channel.

34. The communication network of claim 1 wherein the CES comprises a computer system for a Public Safety Answering Point (PSAP).

35. The communication network of claim 1 wherein the CES comprises a computer system for one of a hospital, a police department, a fire station, a fire alarm company, a security company, an ambulance service, a state 9-1-1 coordinator, the Federal Emergency Management Agency (FEMA), the Department of Homeland Security, the National Geophysical Data Center, or the Center for Disease Control (CDC).

36. A method of operating a communication network for rotating media channels between a plurality of resources of an emergency services network and a conforming emergency system (CES), the method comprising the steps of:
dynamically establishing a first media channel between the CES and one of the resources, and exchanging messages between the CES and the one resource over the first media channel to facilitate the CES in handling emergency events; and
responsive to a triggering event, dynamically establishing a second media channel between the CES and one of the resources, and exchanging messages between the CES and the one resource over the second media channel to facilitate the CES in handling emergency events.

37. The method of claim 36 wherein the one resource for the first media channel and the one resource for the second media channel comprise the same resource.

38. The method of claim 36 wherein the one resource for the first media channel and the one resource for the second media channel comprise a different resource.

39. The method of claim 36 further comprising the step of:
tearing down the first media channel after the second media channel is established.

40. The method of claim 36 further comprising the step of:
tearing down the first media channel simultaneously as the second media channel is established.

41. The method of claim 36 further comprising the step of:
tearing down the first media channel before the second media channel is established.

42. The method of claim 36 further comprising the step of:
tearing down the first media channel after message sessions on the first media channel have ended.

43. The method of claim 36 further comprising the step of:
rolling message sessions on the first media channel to the second media channel before tearing down the first media channel.

44. The method of claim 36 wherein the triggering event comprises a time period elapsing.

45. The method of claim 36 wherein the triggering event comprises a request from the CES, the one resource for the first media channel, the one resource for the second media channel, or another system.

46. The method of claim 36 wherein the triggering event comprises the CES receiving a new emergency event.

47. The method of claim 36 wherein:
the step of dynamically establishing the first media channel comprises transmitting a first request message for the first media channel from the CES to the transport network, receiving the first request message in the one resource for the first media channel, and responding to the first request message to dynamically establish the first media channel between the CES and the one resource for the first media channel; and
the step of dynamically establishing the second media channel comprises transmitting a second request message for the second media channel from the CES to the transport network, receiving the second request message in the one resource for the second media channel, and responding to the second request message to dynamically establish the second media channel between the CES and the one resource for the second media channel.

48. The method of claim 47 wherein the step of responding to the first request message comprises transmitting a response message indicating an acceptance of the first media channel from the one resource for the first media channel to the transport network, the method further comprising the steps of:
receiving the response message in the CES over the transport network, and initiating a process to dynamically establish the first media channel between the CES and the one resource for the first media channel.

49. The method of claim 47 wherein the step of responding to the first request message comprises initiating a process in the one resource for the first media channel to dynamically establish the first media channel.

50. The method of claim 47 wherein the communication network further comprises a channel setup system connected to the transport network, the method further comprising the steps of:
receiving the first request message in the channel setup system from the CES, selecting the one resource for the first media channel, and transmitting the first request message to the one resource for the first media channel.

51. The method of claim 50 wherein the step of selecting the one resource for the first media channel in the channel setup system comprises:
selecting the one resource for the first media channel by identifying the availability of each of the plurality of resources in the emergency services network.

52. The method of claim 50 wherein the channel setup system includes a data structure that stores information on the plurality of resources, and the step of selecting the one resource for the first media channel in the channel setup system comprises:
accessing the information in the data structure to select the one resource for the first media channel.

53. The method of claim 52 wherein the information in the data structure includes at least one of a capacity or current load of each of the plurality of resources, an operational status of each of the plurality of resources, a number of media channels established with each of the plurality of resources, security, a location of each resource, data connectivity speed of each resource, the type of protocol used by each resource, and the type of each resource.

54. The method of claim 50 wherein the channel setup system comprises a Session Initiation Protocol (SIP) proxy or a SIP server.

55. The method of claim 50 wherein the step of responding to the first request message comprises transmitting a response message indicating an acceptance of the first media channel to the channel setup system, the method further comprising the step of:
transmitting the response message from the channel setup system to the CES.

56. The method of claim 50 wherein the step of responding to the first request message comprises transmitting a response message indicating an acceptance of the first media channel to the CES.

57. The method of claim 36 wherein:
the step of dynamically establishing the first media channel comprises transmitting a first request message for the first media channel from the one resource for the first media channel to the transport network, receiving the first request message in the CES, and responding to the first request message to dynamically establish the first media channel between the CES and the one resource for the first media channel; and
the step of dynamically establishing the second media channel comprises transmitting a second request message for the second media channel from the one resource for the second media channel to the transport network, receiving the second request message in the CES, and responding to the second request message to dynamically establish the second media channel between the CES and the one resource for the second media channel.

58. The method of claim 57 wherein the step of responding to the first request message comprises transmitting a response message indicating an acceptance of the first media channel from the CES to the transport network, the method further comprising the steps of:
receiving the response message in the one resource for the first media channel over the transport network, and initiating a process to dynamically establish the first media channel between the CES and the one resource for the first media channel.

59. The method of claim 57 wherein the step of responding to the first request message comprises initiating a process in the CES to dynamically establish the first media channel.

60. The method of claim 57 wherein the communication network further comprises a channel setup system connected to the transport network, the method further comprising the steps of:
receiving the first request message in the channel setup system from the one resource for the first media channel, and transmitting the first request message to the CES.

61. The method of claim 60 wherein the channel setup system comprises a Session Initiation Protocol (SIP) proxy or a SIP server.

62. The method of claim 60 wherein the step of responding to the first request message comprises transmitting a response message indicating an acceptance of the first media channel to the channel setup system, the method further comprising the step of:
transmitting the response message from the channel setup system to the one resource for the first media channel.

63. The method of claim 60 wherein the step of responding to the first request message comprises transmitting a response message indicating an acceptance of the first media channel to the one resource for the first media channel.

64. The method of claim 36 further comprising the step of:
using Session Initiation Protocol (SIP) to dynamically establish the first media channel.

65. The method of claim 36 wherein the plurality of resources includes a response gateway.

66. The method of claim 36 wherein the plurality of resources includes at least one of an ALI database, a Mobile Positioning Center (MPC), a Gateway Mobile Location Center (GMLC), an Emergency Auxiliary Service Provider (EASP), and a Voice over Internet Protocol (VoIP) server.

67. The method of claim 36 wherein the emergency events include 9-1-1 calls.

68. The method of claim 36 wherein the CES exchanges one of streaming video, streaming audio, graphics data, voice, text or binary data, or executable instructions or scripts over the first media channel.

69. The method of claim 36 wherein the CES comprises a computer system for a Public Safety Answering Point (PSAP).

70. The method of claim 36 wherein the CES comprises a computer system for one of a hospital, a police department, a fire station, a fire alarm company, a security company, an ambulance service, a state 9-1-1 coordinator, the Federal Emergency Management Agency (FEMA), the Department of Homeland Security, the National Geophysical Data Center, or the Center for Disease Control (CDC).

71. A conforming emergency system (CES) that rotates media channels with resources of an emergency services network, the CES comprising:
a channel system that dynamically establishes a first media channel with one of the resources of the emergency services network; and
a message system, responsive to the first media channel being established, that exchanges messages over the first media channel with the one resource for the first media channel to facilitate the CES in handling emergency events;
the channel system, responsive to a triggering event, dynamically establishes a second media channel with one of the resources of the emergency services network;
the message system, responsive to the second media channel being established, exchanges messages over the second media channel with the one resource for the second media channel to facilitate the CES in handling emergency events.

72. The CES of claim 71 wherein the channel system dynamically establishes the first media channel by transmitting a first request message for a first media channel to a transport network, and initiating a process to dynamically establish the first media channel between the CES and the one resource for the first media channel responsive to receiving a first response message from the one resource for the first media channel over the transport network.

73. The CES of claim 71 wherein:
the channel system tears down the first media channel after the second media channel is established.

74. The CES of claim 71 wherein:
the channel system tears down the first media channel simultaneously as the second media channel is established.

75. The CES of claim 71 wherein:
the channel system tears down the first media channel before the second media channel is established.

76. The CES of claim 71 wherein:
the channel system tears down the first media channel after message sessions by the message system on the first media channel have ended.

77. The CES of claim 71 wherein:
the message system rolls message sessions on the first media channel to the second media channel before tearing down the first media channel.

78. The CES of claim 71 wherein the triggering event comprises a time period elapsing.

79. The CES of claim 71 wherein the triggering event comprises a request from the channel system, the one resource for the first media channel, the one resource for the second media channel, or another system.

80. The CES of claim 71 wherein the triggering event comprises the CES receiving a new emergency event.

81. The CES of claim 71 wherein:
the channel system negotiates parameters of the first media channel before the first media channel is established.

82. The CES of claim 71 wherein the channel system uses Session Initiation Protocol (SIP) to dynamically establish the first media channel.

83. The CES of claim 82 wherein the channel system comprises a SIP user agent.

84. The CES of claim 71 wherein the CES comprises a computer system for one of a Public Safety Answering Point (PSAP), a hospital, a police department, a fire station, a fire alarm company, a security company, an ambulance service, a state 9-1-1 coordinator, the Federal Emergency Management Agency (FEMA), the Department of Homeland Security, the National Geophysical Data Center, or the Center for Disease Control (CDC).

85. A method of operating a conforming emergency system (CES) for rotating media channels with resources of an emergency services network, the method comprising the steps of:
dynamically establishing a first media channel with one of the resources of the emergency services network;
exchanging messages over the first media channel with the one resource for the first media channel to facilitate the CES in handling emergency events;
responsive to a triggering event, dynamically establishing a second media channel with one of the resources of the emergency services network; and
exchanging messages over the second media channel with the one resource for the second media channel to facilitate the CES in handling emergency events.

86. The method of claim 85 wherein the step of dynamically establishing the first media channel comprises:
transmitting a first request message for a first media channel to a transport network;
receiving a first response message from the one resource for the first media channel over the transport network; and
initiating a process to dynamically establish the first media channel between the CES and the one resource for the first media channel.

87. The method of claim 85 further comprising the step of:
tearing down the first media channel after the second media channel is established.

88. The method of claim 85 further comprising the step of:
tearing down the first media channel simultaneously as the second media channel is established.

89. The method of claim 85 further comprising the step of:
tearing down the first media channel before the second media channel is established.

90. The method of claim 85 further comprising the step of:
tearing down the first media channel after message sessions on the first media channel have ended.

91. The method of claim 85 further comprising the step of:
rolling message transfers on the first media channel to the second media channel before tearing down the first media channel.

92. The method of claim 85 wherein the triggering event comprises a time period elapsing.

93. The method of claim 85 wherein the triggering event comprises a request from the CES, the one resource for the first media channel, the one resource for the second media channel, or another system.

94. The method of claim 85 wherein the triggering event comprises the CES receiving a new emergency event.

95. The method of claim 85 further comprising the step of:
negotiating parameters of the first media channel before the first media channel is established.

96. The method of claim 85 wherein the step of dynamically establishing the first media channel comprises:
dynamically establishing the first media channel using Session Initiation Protocol (SIP).

97. The method of claim 85 wherein the CES comprises a computer system for one of a Public Safety Answering Point (PSAP), a hospital, a police department, a fire station, a fire alarm company, a security company, an ambulance service, a state 9-1-1 coordinator, the Federal Emergency Management Agency (FEMA), the Department of Homeland Security, the National Geophysical Data Center, or the Center for Disease Control (CDC).
